(19) United States
(12) Patent Application Publication
(10) Pub. No.: US 2020/0166010 A1
(43) Pub. Date: May 28, 2020

(54) SYSTEM AND METHOD FOR SUSTAINABLE GENERATION OF ENERGY

(71) Applicants: Perry VAN DER BOGT, Hoek van Holland (NL); Willibrordus Nicolaas Johannes URSEM, Amsterdam (NL)

(72) Inventors: Perry VAN DER BOGT, Hoek van Holland (NL); Willibrordus Nicolaas Johannes URSEM, Amsterdam (NL)

(21) Appl. No.: 16/340,940

(22) PCT Filed: Oct. 11, 2017
(86) PCT No.: PCT/IB2017/001780

§ 371 Date: Apr. 10, 2019

(30) Foreign Application Priority Data
Oct. 11, 2016 (NL) NL 1042097

(51) Int. Cl. F02M 26/35; F01N 5/02; F03B 13/14; F02G 1/043; F01N 3/08; F03D 9/10; B01D 5/00; B01D 53/00

(52) U.S. Cl. CPC F02M 26/35; F01N 5/025; F03B 13/14; F02G 1/043; F01N 2240/30; F03D 9/10; B01D 5/0036; B01D 53/002; F01N 3/08

(57) ABSTRACT

A system for sustainable generation of energy, comprising at least one device for converting natural power into useful energy, and at least one internal combustion engine or heat engine. The internal combustion engine or heat engine may be connected to a gas cleaning device for fuel or heat supply. A method for sustainable generation of energy, comprising the steps of generating a first amount of useful energy by converting natural power; and generating a second amount of energy by operating at least one internal combustion engine or heat engine, wherein the internal combustion engine or heat engine is driven by fuel or heat derived from cleaning a waste gas.

The invention relates to a system for sustainable generation of energy, comprising at least one device for converting natural power into useful energy, and at least one internal combustion engine or heat engine.

In view of growing concerns about the worldwide environment and the depletion of fossil fuel reserves, there is increasing interest in sustainable systems and methods for generating energy. By sustainable energy generation the present application means energy generation which involves little or no fossil fuels and little or no harmful emissions.

A problem with an energy supply that is wholly dependent on natural sources, like solar power or wind power, is the non-continuous and unpredictable character of these sources. Therefore, some form of non-natural energy is usually necessary, at least as a backup.

The invention has for its purpose to provide a system for sustainable generation of energy, which is more reliable and predictable than fully natural energy generation systems, while having a lower fuel consumption and smaller carbon footprint than systems which rely on a fossil fuel driven backup generator.

In accordance with the invention this is achieved in that the internal combustion engine or heat engine is connected to a gas cleaning device for fuel or heat supply. By using fuel or heat derived from cleaning a waste gas, the total fuel consumption and carbon footprint is reduced.

Preferred embodiments of the system of the invention form the subject matter of dependent claims 2-7.

The invention also relates to a method for sustainable generation of energy. Such a method may comprise the steps of generating a first amount of useful energy by converting natural power; and generating a second amount of energy by operating at least one internal combustion engine or heat engine. In accordance with the invention, the internal combustion engine or heat engine is driven by fuel or heat derived from cleaning a waste gas.

Preferred ways of carrying out this method are defined in dependent claims 9-12.

The invention is now further elucidated by way of a number of exemplary embodiments, with reference being made to the annexed drawings, in which:

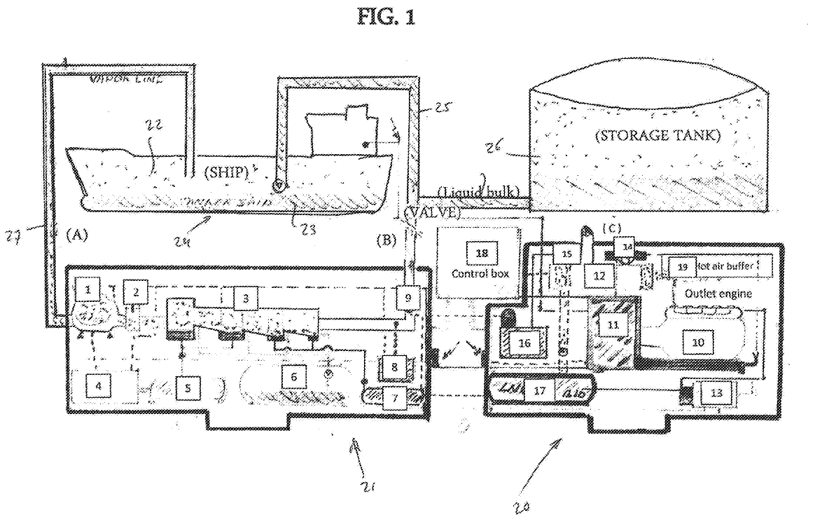

FIG. 1 is a schematic representation of a combined gas cleaning apparatus and non-natural energy converter in use for degassing a tank of a ship;

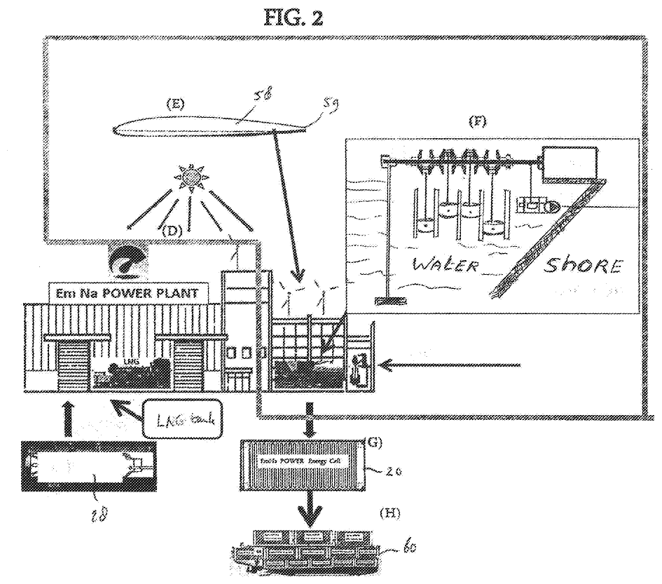

FIG. 2 is a schematic representation of a system for sustainable energy generation in accordance with an embodiment of the invention;

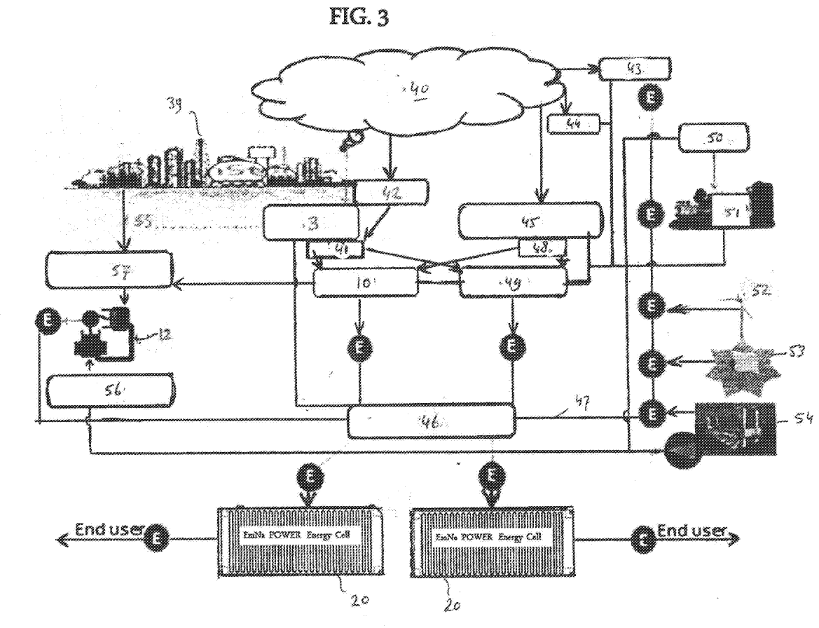

FIG. 3 is a schematic representation of a system for sustainable energy generation in accordance with a further embodiment of the invention;

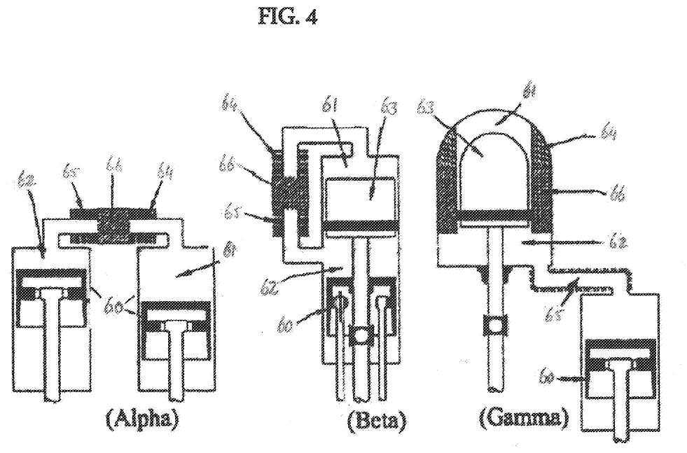

FIG. 4 shows three schematic representations of heat engines for use in the system of the invention;

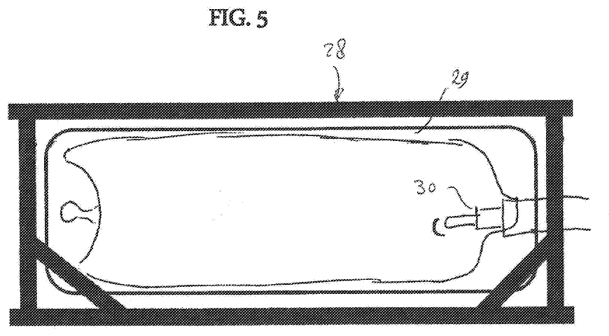

FIG. 5 is a schematic side view of a tank for storing fuel derived from a waste gas stream;

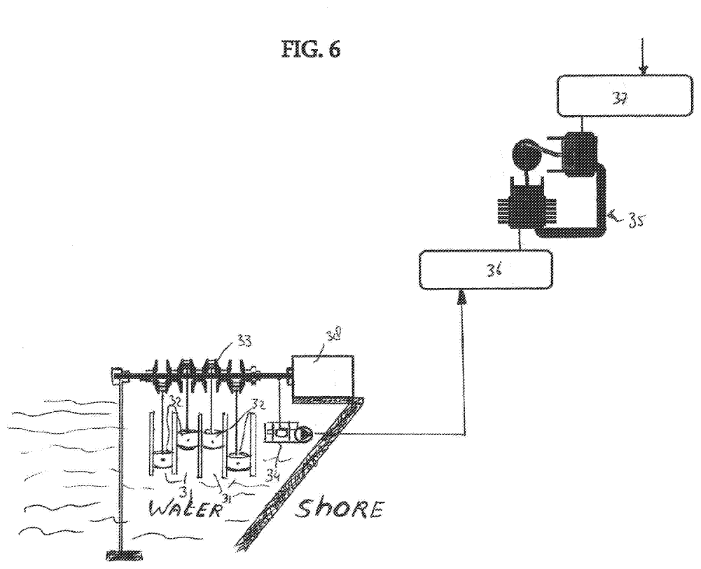

FIG. 6 is a schematic representation of an additional part of the sustainable energy generation system of FIG. 2;

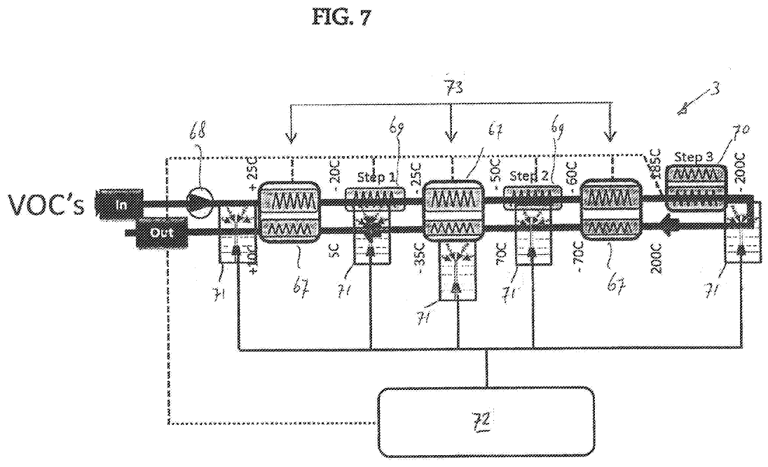

FIG. 7 schematically shows an embodiment of the multi-stage condenser of the gas cleaning apparatus of FIG. 1;

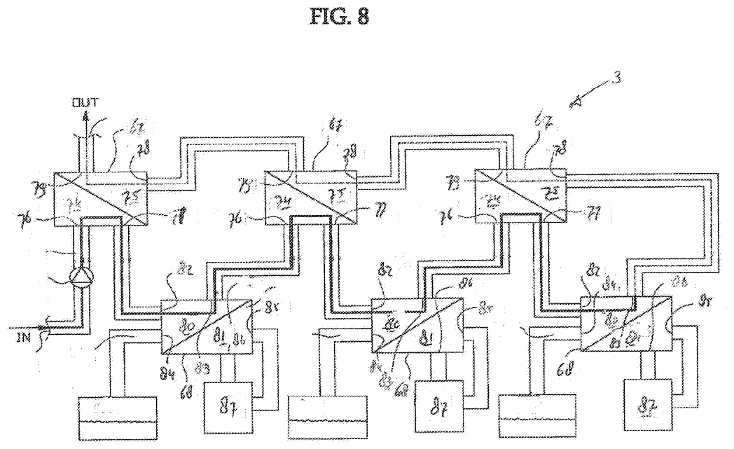

FIG. 8 schematically shows another embodiment of the multi-stage condenser of FIG. 7;

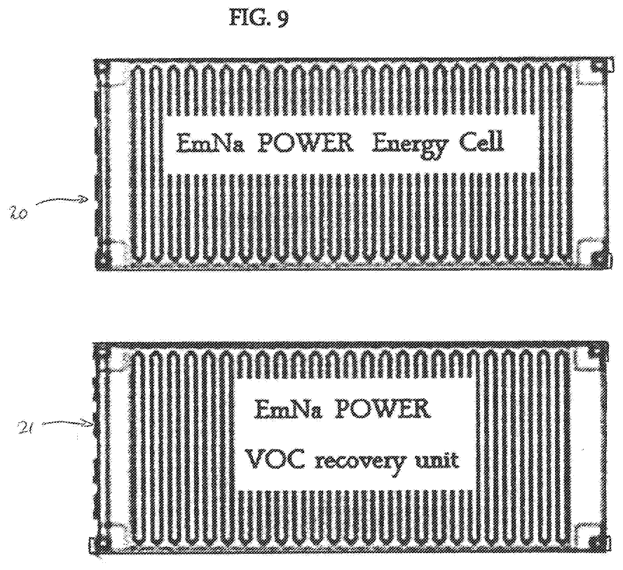

FIG. 9 shows the containers housing the gas cleaning apparatus and non-natural energy converter of FIG. 1;

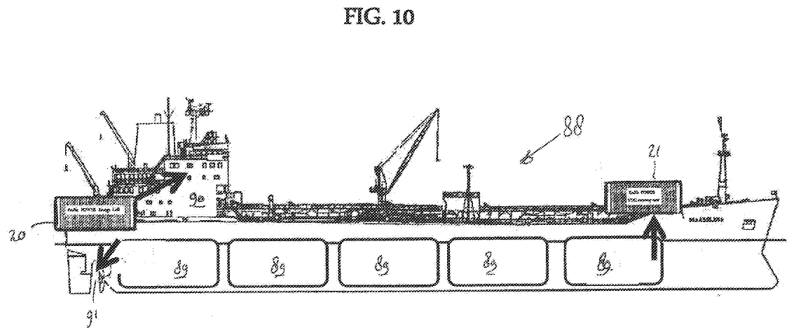

FIG. 10 schematically shows a ship provided with the gas cleaning apparatus and non-natural energy converter of FIG. 1;

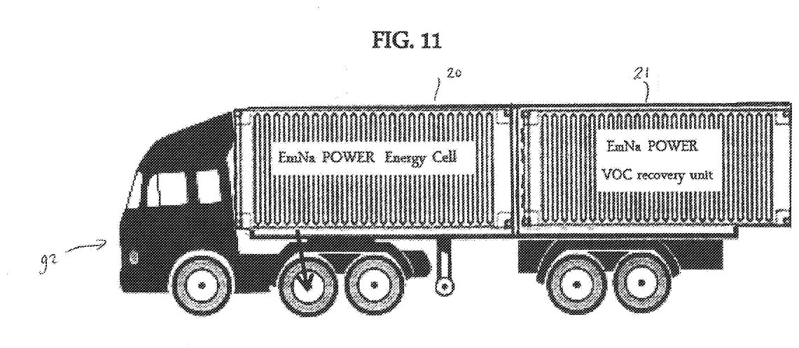

FIG. 11 schematically shows a road transport vehicle provided with the gas cleaning apparatus and non-natural energy converter of FIG. 1;

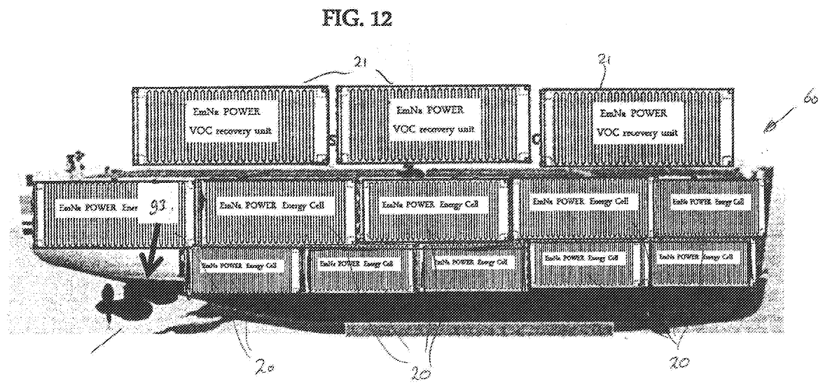

FIG. 12 schematically shows a barge provided with a plurality of gas cleaning apparatuses and non-natural energy converters as shown in FIG. 1; and

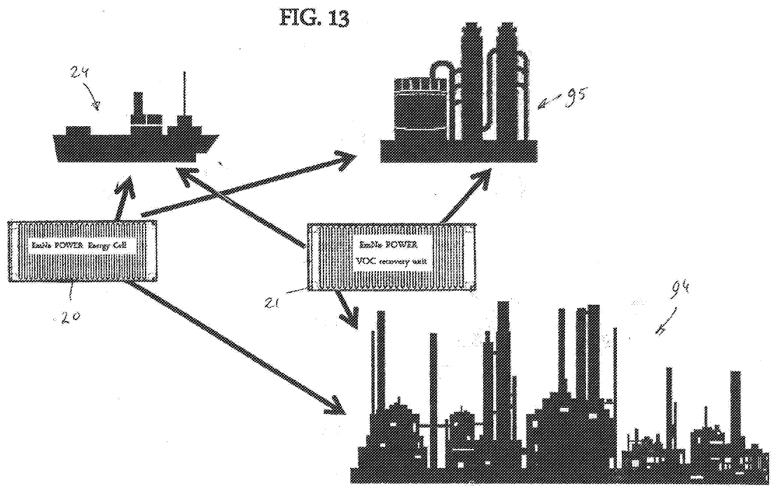

FIG. 13 schematically shows the gas cleaning apparatus and non-natural energy converter of FIG. 1 in use for both off-shore and on-shore purposes.

A system for sustainable generation of energy comprises one or more devices for converting natural power into useful energy and one or more internal combustion engines or heat engines. In the embodiment shown in FIG. 2, the devices for converting natural power into useful energy include a solar power converter D, a wind power converter or wind turbine E, and a wave energy converter F.

The internal combustion engine 10 and/or the heat engine 12 may form part of a non-natural energy converter 20, which is connected to a gas cleaning apparatus 21 (FIG. 1). Such a combined gas cleaning apparatus 20 and non-natural energy converter 21 are described in detail in prior art document GB 2532224 A (hereafter GB224) by one of the present inventors.

The gas cleaning apparatus 21 serves to clean a stream of waste gas, e.g. a volume of gas 22 which exists above a volume of fuel 23 in a tank of a ship (e.g. an LNG tanker) 24. While the fuel 23 is pumped from the ship 24 through a discharge line 25 to an onshore storage tank 26, the gas 22 may be withdrawn through a vapour line 27 under the influence of a suction fan 1 of the gas cleaning apparatus 21.

As described in more detail in the above mentioned document GB224, the gas cleaning apparatus 21 further comprises a dew point cold steering unit 2 and a hybrid heat exchange unit 3 which is operable to cool extracted gas supplied via the dew point cold steering unit 2 to enable an extraction of volatile components from the extracted gas. Firstly, the extracted gas is cooled in the hybrid heat exchange unit 3 to a low temperature, and then reheated to be vented to ambient atmosphere as clean air or re-injected into the gaseous region of the ships tank via a valve 9. The gas cleaning apparatus 21 further comprises a chiller 4, a cool buffer 5, a condensed VOC liquid buffer tank 6, a deep cool buffer 7 and a heater 8, the functions of which are described in detail in GB224. All components of the gas cleaning apparatus 21 may be arranged in a standard container (FIG. 9), which may be cooled and/or isolated.

The non-natural energy converter 20, which is connected to the gas cleaning apparatus 21, and which is controlled by a common control box 18, includes the internal combustion engine 10 and the heat engine 12, as well as an electric generator 11 which is driven by the internal combustion engine 10 and/or the heat engine 12. The non-natural energy converter 21 further includes a demister 13, an alternator 14, an inert gas generator 15, an inert gas buffer 16, a fuel buffer tank 17 for (bio-)LNG and a hot air buffer tank 19. All components of the non-natural energy converter 20 may also be arranged in a standard container (FIG. 9).

As shown in FIG. 2, the non-natural energy converter 20 may supplement the natural energy converters D, E and F when the sun is not shining, there is too little wind and/or when waves are low. All energy converters may be connected to a common network, e.g. an electricity grid or a heat distribution network. Fuel that is derived by condensation of volatile organic compounds may be temporarily stored in a buffer tank 28 for later use in the non-natural energy converter 20.

The fuel buffer tank 28 comprises a specially lined container 29 in a frame, which further includes a specially designed telescopic nozzle 30 to prevent vapour being formed during loading/unloading and transport (FIG. 5).

The wave energy generation device F includes cylinders 31 and pistons 32 arranged below the waterline, which are connected to a crankshaft 33 above the water. The cylinders act as communicating vessels to generate electrical energy by a generator 38 that is driven by the crankshaft. The crankshaft 33 also drives a pump 34 that pumps cold water to an on-shore heat engine 35. The heat engine 35 is driven by the temperature differential between the cold 36 of the water and residual heat 37 from e.g. an industrial estate or households (FIG. 6) or heat from a non-natural energy converter 20.

The system of FIG. 2 may further include a remote controlled self-propelled vessel 60, which may carry a plurality of gas cleaning apparatuses 21 and which may be energized by a plurality of non-natural energy converters 20. This vessel or barge 60 may be used to energize other ships or installations during their stay in port and may serve as a floating power station. It may further serve as a degassing station, due to the presence of the gas cleaning apparatuses 21.

Although not shown in detail, the wind energy converter E may have blades 58 having a special shape, including a corrugated or sinusoidal trailing edge 59.

In FIG. 3 a further embodiment of an integrated energy generation system is shown. VOCs 40 from an industrial estate 39 are used to form a VOC liquid 41 after passing a membrane 42. Alternatively or additionally, the VOCs 40 may be condensed, e.g. in a condenser 3 as shown in FIG. 1, thus forming further VOC liquid 41. This liquid may be used as fuel in an internal combustion engine, e.g. the engine 10 of FIG. 1. Additionally or alternatively, the VOCs may be treated by catalysis 43, photo oxidation 44, or ionization 45, e.g. by thermal plasma.

The latter process leads to the formation of syn gas 48, which may be used as fuel in the internal combustion engine 10. Alternatively or additionally, the syn gas 48 may be used as fuel in a fuel cell installation 49. The liquefied VOCs 41 may also be used as fuel for the fuel cell 49. After catalysis or photo-oxidation the treated VOCs may also be supplied to the fuel cell 49.

Energy, in particular electric energy (identified by the letter E in the black circle) that is generated by the internal combustion engine 10 or the fuel cell 49 may be provided to a substation 46. Heat from the engine 10 and fuel cell 49 may be fed to a heat buffer 57, which also receives industrial waste heat 55.

The illustrated energy generation system further includes a (bio-)LNG storage tank 50 which is connected to a bio LNG engine 51, a wind power converter 52, a solar power converter 53, and a wave power generator 54. All these power generators are connected to a grid 47 which eventually also connects the system to the end users. The wave power generator 54 is further connected to a cold buffer 56, which in turn is connected to a heat engine, e.g. a heat engine 12 as shown in FIG. 1. The heat engine 12 is further connected to the heat buffer 57 and utilizes the temperature differential to generate electrical energy, which is supplied to an end user or to the grid 47.

And finally, the system is shown to include one or non-natural energy converters 20.

All these sources, both natural and non-natural, cooperate to ensure on-demand power generation in a sustainable way.

The system further includes means for temporarily storing the generated energy for later use (not shown). Energy storage is also very important when using natural energy sources. These energy storage means may be gravitational energy storage means, pneumatic energy storage means, kinetic energy storage means and chemical energy storage means.

Examples are rechargeable materials like carbon, graphene, lithium, water, nano-platelets, lead-acid, nickel cadmium, sodium, silicon, hydrogen, organic materials like rhubarb.

Further technologies used in energy storage systems may be:

Solid state batteries, i.e. batteries having both solid electrodes and solid electrolytes.

Flow batteries which are provided by two chemical components dissolved in liquids contained within the system and most commonly separated by a membrane. This technology is akin to both a fuel cell and a battery—where liquid energy sources are tapped to create electricity and are able to be recharged within the same system.

Electrochemical storage systems, where energy is stored in various carbon materials such as graphene.

Magnetic energy storage systems which store electricity from the grid within the magnetic field of a coil comprised of superconducting wire with near-zero loss of energy (connectible to magnetic cooling system).

Flywheels storage systems which use electric energy input to rotate a flywheel which stores the electric energy in the form of kinetic energy.

Compressed air energy storage systems, which store energy as the potential energy of a compressed gas/air.

Thermal storage systems which are based on the temperature change in the material (or liquids) and the unit storage capacity (connectible to heat engines and other systems working on temperature differentials).

Pumped hydro-power storage systems which store and generate energy by moving water between two reservoirs at different elevations (connectible to both wave systems and systems based on temperature differential).

Solar/photo storage systems with efficient photo-degradation consist of a photo anode, and a counter electrode, as well as a charge storage electrode.

Solid-oxide fuel energy storage systems, which convert chemical energy to electrical energy.

Hydrogen energy storage systems, which convert electricity into hydrogen by electrolysis. The hydrogen can be then stored and eventually re-electrified.

FIG. 4 shows various embodiments of heat engines, which may be Stirling engines or other engines working on a similar principle. In each of these embodiments there is a piston 60, an expansion space 61 and a compression space 62. The “Beta” and “Gamma” embodiments further include a displacer 63, whereas the “Alpha” embodiment has two pistons 60. All three embodiments further include a hot side exchanger 64, a cold side exchanger 65 and a regenerator 66.

In FIG. 7 an embodiment of the multi-stage condenser 3 of the gas cleaning apparatus 21 is shown. This condenser includes three heat exchangers 67 where the incoming gaseous stream contaminated with VOCs, which is transported by a pump or fan 68, is brought into heat exchanging contact with the outgoing gaseous stream that is substantially free of VOCs. The condenser 3 further includes two intermediate coolers 69 and a final heat exchanger 70 where a deep cooled fluid is brought into heat exchanging contact with the gaseous stream. All cooling energy is shown to be derived from a single source 73 in this embodiment. Although not shown in this drawing, condensed VOCs can be extracted and collected at various points between the consecutive stages. The temperatures which the gaseous stream may have after each stage as indicated in the drawing are examples only. These temperatures are measured by sensors 71 which are connected to a processing unit 72.

A further example of a multi-stage condenser 3 for use in the gas cleaning apparatus of FIG. 1 is shown in FIG. 8. Here each heat exchanger 67 is shown to have two compartments 74, 75 for the incoming and outgoing gas streams, respectively. Each compartment 74, 75 has an inlet 76, 78 and an outlet 77, 79. Each cooler 68, of which there are three in this embodiment, also has two compartments, one compartment 80 for the incoming gas stream and one compartment 81 for the cooling fluid. The compartment 80 for the gas stream has a gas inlet 82, a gas outlet 83 and a condensate outlet 84. The cooling fluid compartment 81 has an inlet 85 and outlet 86 which are connected to a cooling unit 87.

Apart from being part of an integrated system for sustainable generation of energy, the gas cleaning apparatus 21 and non-natural energy converter 20 may be used separately from the natural energy converters.

In FIG. 10 an embodiment is shown in which a ship 88 is provided with a gas cleaning apparatus 21 arranged above its tanks 89, and with a non-natural energy converter 20 that is connected to the gas cleaning apparatus 21 and that serves to provide energy to the crew accommodation 90 and possibly provide additional drive to the ship's propulsion system 91.

FIG. 11 shows an embodiment where the combination of gas cleaning apparatus 21 and non-natural energy converter 20 is mounted on a truck 92. The purpose of this arrangement is to provide a mobile degassing unit. The energy that is generated by the converter 20 may be supplied to an external user or may be used for driving the truck 92.

In FIG. 12 the remote controlled self-propelled barge 60 of FIG. 2 is shown in more detail. Here again, the gas cleaning apparatuses 21 may be transported to a place of use, where the barge 60 may also serve as a power supply due to the presence of the plurality of non-natural energy converters 20. The energy may also be used for the barge's propulsion system 93.

And finally, in FIG. 13 an embodiment is shown in which the gas cleaning apparatus 21 may be used both on-shore, e.g. at an industrial plant 94 or a building site 95, or off-shore, for degassing a tank of a ship 24. Similarly, the energy converter 20 can be used both on-shore or off-shore. The on-shore use could serve to “shave” peak loads off the grid, i.e. to provide additional energy at times of high demand.

The systems and methods described above allow energy to be generated almost continuously, i.e. without the peaks and troughs normally associated with natural energy sources, while still maintaining a reduced carbon footprint due to the use of waste energy to supplement the naturally sourced energy. As a result, the energy that is generated can be said to be “green”. Moreover, the systems and methods of the invention provide easy access to energy, especially at sites where there is a high demand for energy, like industrial plants or harbours. At the same time, the systems and methods also provide the ability to process industrial waste, in particular VOCs.

The invention is not limited to the embodiments shown, but may be modified in various ways within the scope of the following claims.

1. A system for sustainable generation of energy, comprising:
at least one device for converting natural power into useful energy, and
at least one internal combustion engine or heat engine,
wherein the internal combustion engine or heat engine is connected to a gas cleaning device for fuel or heat supply.

2. The system according to claim 1, wherein the gas cleaning device comprises a multi-stage condenser arrangement.

3. The system according to claim 1, wherein the at least one natural power conversion device is selected from the list consisting of solar power converters, wind turbines, hydro-turbines, wave power converters, geothermal heat pumps and tidal energy converters.

4. The system according to claim 1, wherein the at least one device for converting natural power into useful energy converts waste heat from industry or households into useful energy.

5. The system according to claim 1, further comprising means for storing generated energy.

6. The system according to claim 5, wherein the energy storage means is selected from the list consisting of gravitational energy storage means, pneumatic energy storage means, kinetic energy storage means and chemical energy storage means.

7. The system according to claim 5, wherein the energy storage means comprises a tank for fuel recovered by the gas cleaning device.

8. A method for sustainable generation of energy, comprising the steps of:
generating a first amount of useful energy by converting natural power; and
generating a second amount of energy by operating at least one internal combustion engine or heat engine,
wherein the internal combustion engine or heat engine is driven by fuel or heat derived from cleaning a waste gas.

9. The method according to claim 8, wherein the fuel is formed by condensing volatile organic compounds present in the waste gas.

10. The method according to claim 8, wherein the first amount of energy is generated by converting at least one of solar power, wind power, hydro-power, wave power, geothermal heat and tidal energy.

11. The method according to claim 8, wherein an additional amount of energy is generated by converting waste heat from industry or households.

12. The method according to claim 8, wherein at least part of the generated energy is temporarily stored for use at a later time.
